(19) United States
(12) Patent Application Publication
(10) Pub. No.: US 2008/0194200 A1
(43) Pub. Date: Aug. 14, 2008

(54) Wireless Communicators

(75) Inventors: Ian Keen, Yately (GB); Peter Symons, Leicestershire (GB); Heikki Huomo, Gloucestershire (GB)

Correspondence Address: LERNER, DAVID, LITTENBERG,;KRUMHOLZ & MENTLIK, 600 SOUTH AVENUE WEST, WESTFIELD, NJ, 07090, US

(73) Assignee: INNOVISION RESEARCH & TECHNOLOGY PLC, GLOUCESTERSHIRE (GB)

(21) Appl. No.: 11/667,874

(22) PCT Filed: Nov. 16, 2005
(86) PCT No.: PCT/GB2005/004407

§ 371 Date: Sep. 20, 2007

(30) Foreign Application Priority Data
Nov. 18, 2004 (GB) 0425423.1

(51) Int. Cl. H04B 5/00

(52) U.S. Cl. 455/41.1

(57) ABSTRACT

A near field communicator has a driver (6) to supply a drive signal to drive an antenna (10) to generate a magnetic field. A magnetic field sensor (18) is located so as to be within a magnetic field generated by the antenna (6) to sense a magnetic field characteristic. A controller (17) provides a control signal to control the operation of the driver (6) to compensate for any difference between the magnetic field characteristic sensed by the magnetic field sensor (18) and a predetermined parameter.

This invention relates to wireless communicators, in particular near field wireless communicators and devices, systems or apparatus having near field wireless communicator functionality.

Near field communication requires the antenna of one near field communicator to be present within the alternating magnetic field (the H field) generated by the antenna of another near field communicator by transmission of an RF signal, for example a 13.56 Mega Hertz signal. The RF signal is thus inductively coupled between the communicators. The RF signal may be modulated to enable communication of control instructions and/or data and/or may be used by the receiving communicator to derive a power supply.

Examples of near field communicators are RFID (Radio Frequency Identification) transceivers (“readers”) or transponders (“tags”) that operate under the RFID ISO/IEC 14443A protocol or ISO/IEC 15693 protocol or NFC (Near Field Communication) communicators operating under the NFCIP-1 (ISO/IEC 18092) or NFCIP-2 (ISO/IEC 21481) protocol. The phrase “near field communicator” will be used herein for any communicator that communicates using radio frequency in the near field (that is the H-field). The phrase “RFID tag” will be used herein for any near field communicator which is operable to respond to a received RF signal by transmission of its own RF signal or through modulation of or interference with the received RF signal. The phrase “RFID reader” will be used herein for any near field communicator which initiates the transmission of an RF signal and which is operable to wait for a response from any near field communicators within the near field of the RF signal. The phrase “NFC communicator” will be reserved for communicators operable to both initiate transmission of an RF signal and to respond to a received RF signal initiated by a second near field communicator. NFC communicators are therefore able to communicate with other NFC communicators, RFID readers and RFID tags.

Such near field communicators may be discrete standalone devices, systems or apparatus or may be incorporated into or provided as part of the functionality of larger host devices, systems or apparatus, for example a consumer product such as a portable communications device having telecommunications capability (for example a mobile telephone (cellphone) or a telecommunications-enabled personal digital assistant or other computing device).

The presence of metallic and/or magnetic materials, especially ferro-magnetic materials, and conductive loop paths in the vicinity of the antenna of a near field communicator can have a profound effect on the range over which the antenna's signal can be read (the “read range”) because of the induction of eddy currents and the consequential eddy current loses.

Housings or casings (which may of course be metallic, plastics or a mixture of metallic and plastics elements), integral batteries, associated electronic circuitry, connectors (nuts, bolts, screws etc.) will all have an effect on the read range of a near field communicator.

Generally, the functionality of such a near field communicator is provided as a semiconductor integrated circuit to which a number of passive components and the antenna are added. The internal metal components of any host device, system or apparatus will as far as possible be located as far away as possible from the near field communicator's antenna. Compensation for the effects of any such metallic components or elements is normally effected by adjusting the capacitance value of a discrete “trimming” capacitor or by selecting a “select-on-test” type fixed capacitor or number of capacitor values during production testing of the host device, system or apparatus. However, this increases unit costs because of the cost of additional component(s), the impact on the printed circuit board costs and the costs involved in the testing and trimming or selecting operations. Further, the addition of such components may adversely affect the life and reliability of the communicator. Also, there may be circumstances in which it is not possible for the antenna circuitry to be adapted to the host device, system or apparatus or the configuration of the host device, system or apparatus may change (for example parts may be removed and new sections added) throughout its life. Furthermore, if a common near field communicator circuit design is produced for a number of different host applications, those host applications will almost certainly have different antenna spatial envelopes, different dimensions, shapes, footprints or sizes (form factors) and differently located or distributed metallic material components or elements, so requiring different compensation component values for each different host application in order to achieve and maintain optimum performance. This results in a large overhead (both in terms of costs and resources) for a company supplying or using near field communicators in a range of host devices, systems or apparatus.

In addition, the near field communicator designer has no way of predicting the electromagnetic influences in the environment or environments within which the near field communicator will operate or how they may change with time. Even the effect of a user on the near field communicator may change in dependence upon the metallic and/or magnetic properties of what the user is wearing or carrying or even whether the user's hands are sweaty.

A further issue is that, in order to create the strongest magnetic field for the lowest drive power, near field communicators generally use an antenna circuit tuned to have a resonant frequency coinciding with or very close to the operating carrier frequency of the near field communicator. One of the most influential parameters of a resonant circuit is its “Q” factor and to achieve optimum read range performance, especially when using small size (small form factor) antennas, relatively high Q factors are used. Although this achieves maximum read range it also makes the communicator very sensitive to the de-tuning effects of nearby metallic and/or magnetic materials. Indeed, the inventors have realised that these de-tuning effects can be more dominant than the unavoidable eddy current loses.

In addition during normal operation of near field communicators, such communicators will communicate with all kinds of different near field communicators each of which has different antenna sizes and form factors and each of which will operate at differing distances from the antenna of the transmitting communicator. All of these factors will have an effect on the H-field and therefore the signal strength of the RF signal produced by the near field communicator.

In one aspect, the present invention provides a near field communicator having a magnetic field strength determiner and an antenna drive adjuster operable to adjust the drive to an antenna of the communicator in accordance with the determined magnetic field strength to provide the communicator with the required read range performance.

In one aspect, the present invention provides a near field communicator which is able to adjust the magnetic field it transmits without the need for user or other intervention.

In one aspect, the present invention provides a near field communicator comprising a driver operable to drive an antenna or coil to produce a magnetic field; a magnetic field sensor operable to sense the magnetic field produced by the antenna or coil; a comparator operable to compare, directly or indirectly, the sensed magnetic field strength with a desired parameter, and a controller operable to control the driver to compensate for a difference between the sensed magnetic field strength and the desired parameter.

In an embodiment, the desired parameter represents a predetermined magnetic field strength.

In an embodiment, the controller is operable to control the driver to control the magnetic signal strength produced by the antenna.

In an embodiment, the near field communicator comprises an RFID reader, an NFC device and/or an RFID tag.

In an embodiment, the magnetic field sensor comprises at least one sense antenna or coil located to lie within the magnetic field of the antenna or coil.

In an embodiment, the controller is operable to control the driver using proportional, integral and differential (PID) techniques or algorithms.

Embodiments of the present invention will now be described, by way of example, with reference to the accompanying drawings, in which:

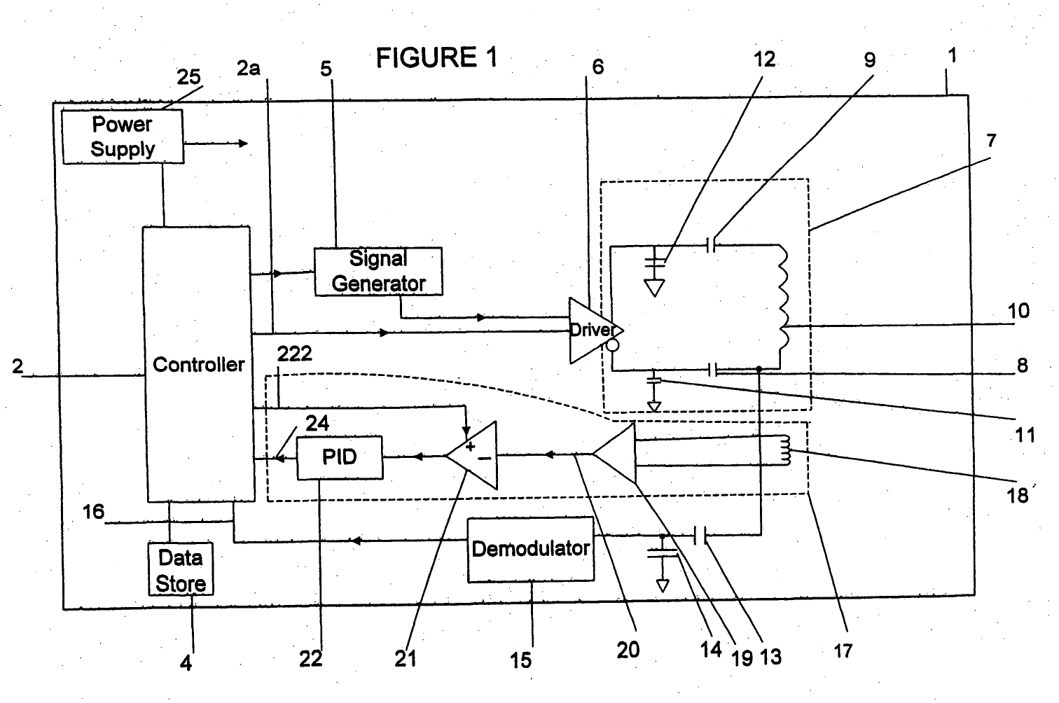

FIG. 1 shows a functional block diagram of an embodiment of an RFID reader in accordance with the invention;

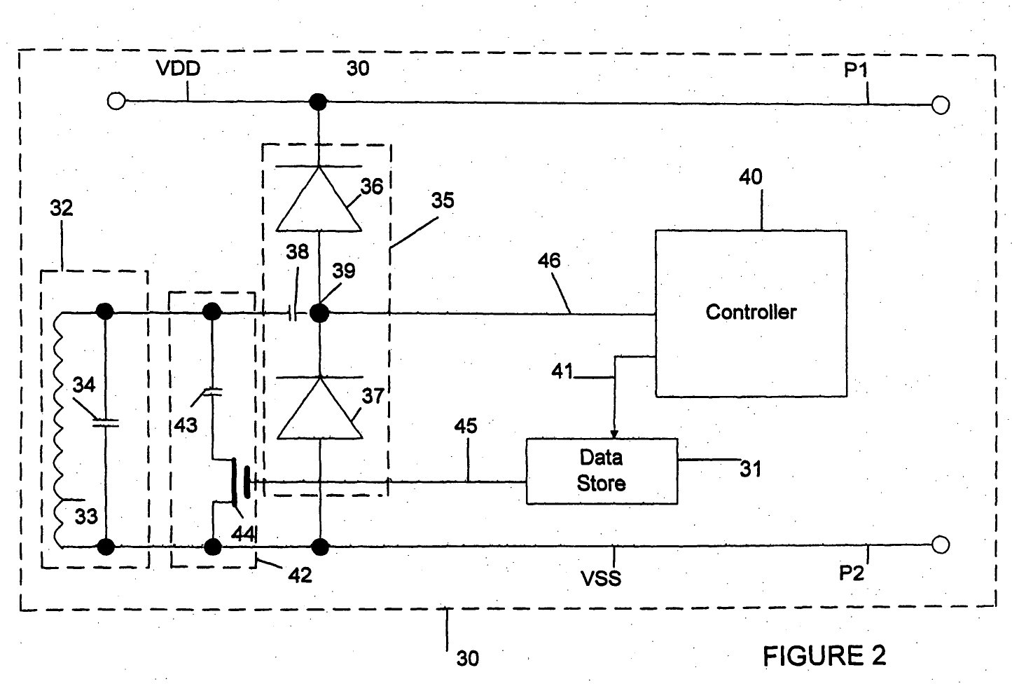

FIG. 2 shows a functional block diagram of an RFID tag that may be read by the reader shown in FIG. 1;

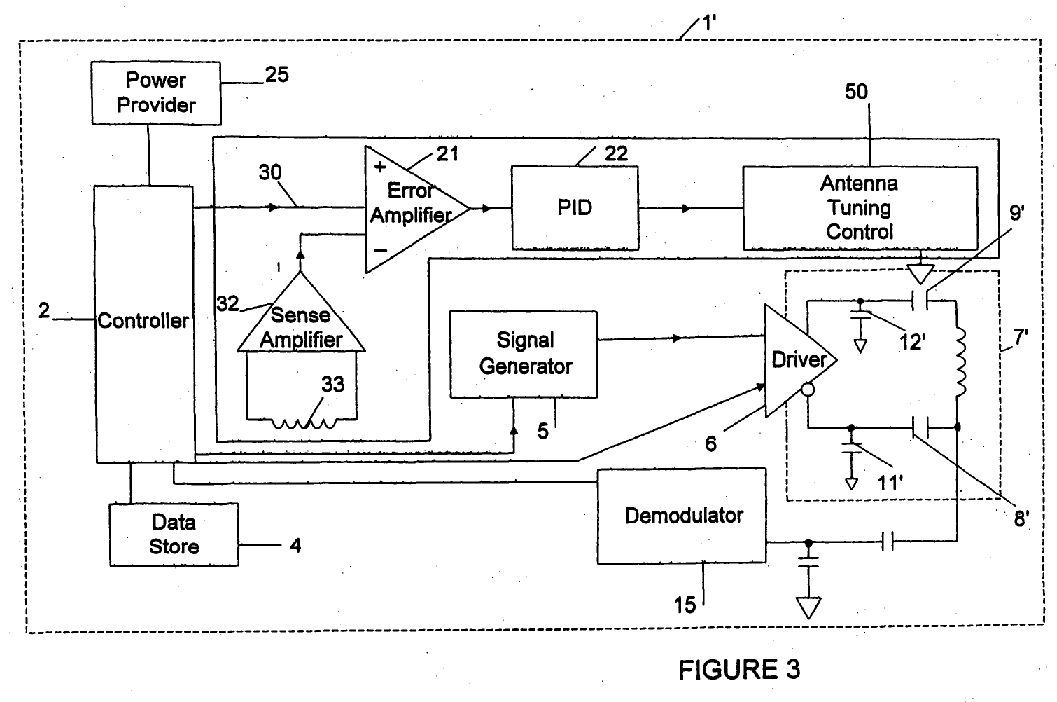

FIG. 3 shows a functional block diagram of another embodiment of an RFID reader in accordance with the invention;

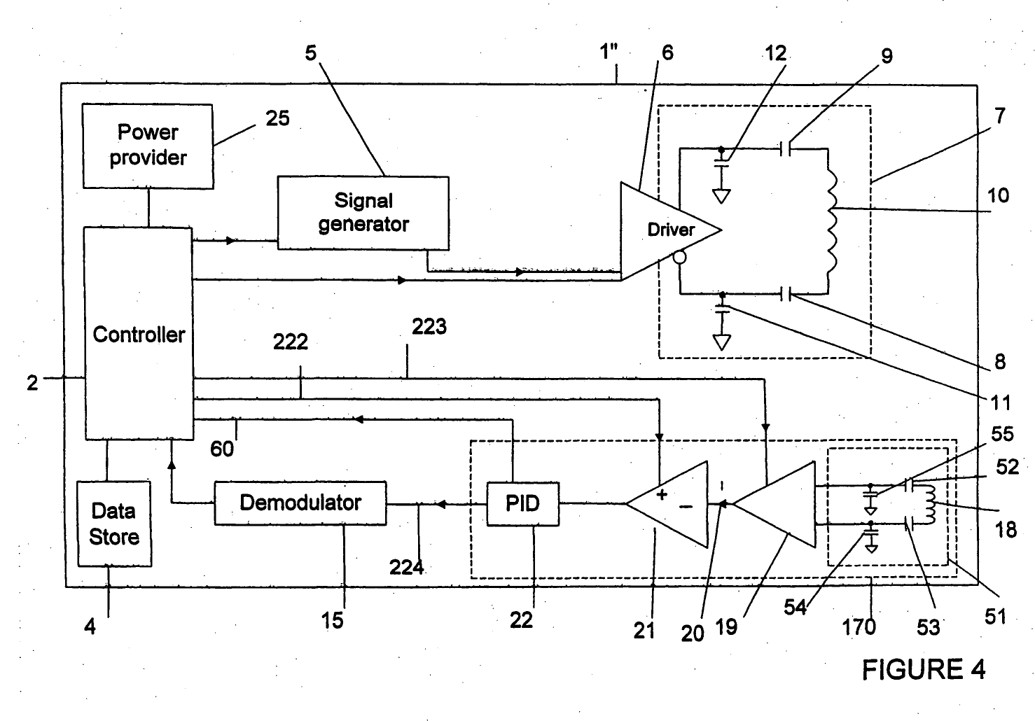

FIG. 4 shows a functional block diagram of another embodiment of an RFID reader in accordance with the invention;

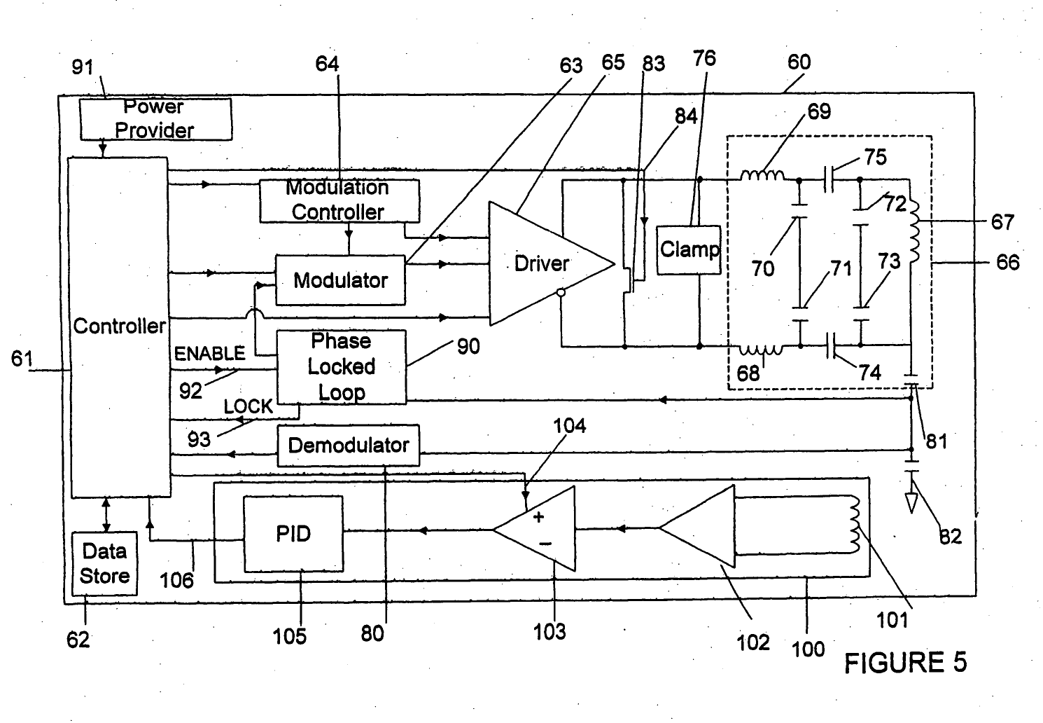

FIG. 5 shows a functional block diagram of an embodiment of an NFC communicator in accordance with the invention;

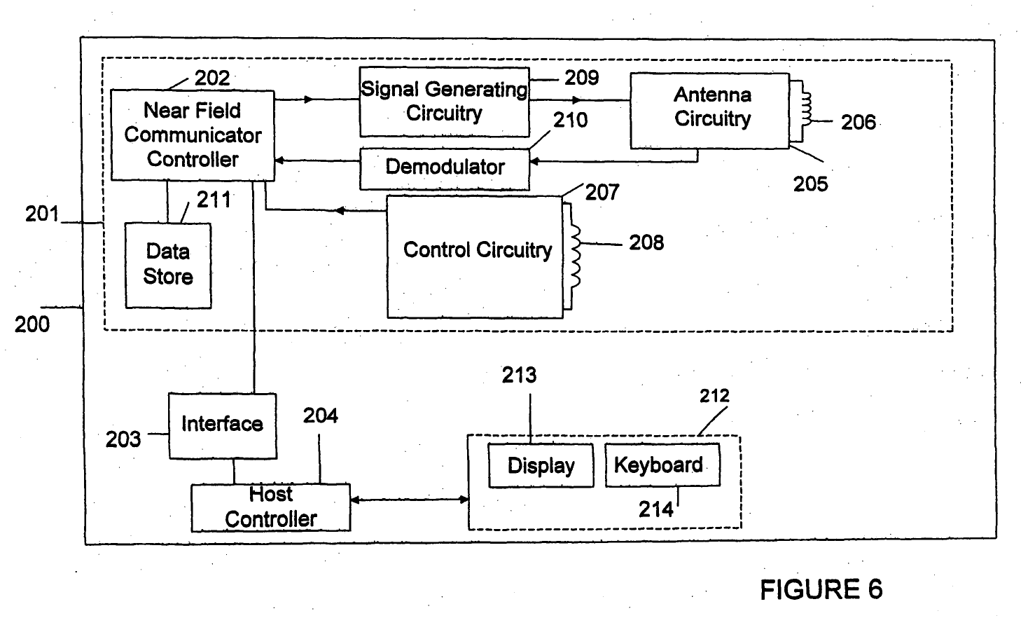

FIG. 6 shows a simplified diagram of a host apparatus, system or device comprising a near field communicator embodying the invention; and

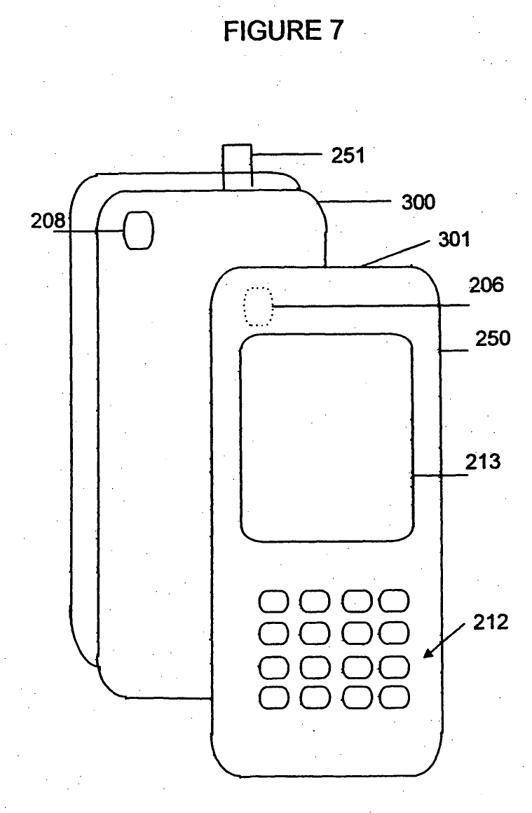

FIG. 7 shows a simplified view of a mobile telephone incorporating a near field communicator embodying the invention.

Referring now to the drawings, like elements in different Figures are represented by like numerals.

FIG. 1 shows a functional block diagram of an embodiment of an RFID reader 1 in accordance with the invention which is operable to transmit a radio frequency signal and to detect and demodulate modulation of the transmitted radio frequency signal. The RFID reader 1 may be compatible with a variety of standards or communications protocols, for example ISO/IEC 14443 or ISO/IEC 15693.

The RFID reader 1 comprises a controller 2 for controlling operation of the RFID reader 1 including controlling the communication protocol under which the RFID reader operates, the data supplied to any receiving near field communicator and the modulation of any generated magnetic field. The controller 2 may be, for example, a microprocessor, a microcontroller (for example a reduced instruction set computer) or state machine. The choice will depend on the design of the reader and operational requirements. The controller 2 is coupled to a data store 4 which may be of, for example EEPROM, ROM, RAM or other memory format.

The controller 2 is also coupled to a signal generator 5 for generating a radio frequency signal (for example a 13.56 Mega Hertz RF signal). The generated RF signal may be unmodulated or modulated with control or other data supplied by the controller 2. The signal generator 5 may generate the RF signal in a variety of ways. For example the RF signal may be a digital signal generated by sine synthesis in which case any required modulation will generally be effected by pulse-width modulation (PWM), pulse code modulation or pulse-density modulation (PDM) techniques. As another possibility, the RF signal may be a digital signal generated by use of a pre-configured algorithm or direct digital synthesis. Where sine synthesis is not used additional filtering circuitry may be required (not shown) to meet electromagnetic energy emissions regulations. Other possible modulation schemes that may be used include amplitude shift key (ASK) modulation and load modulation.

The output of the signal generator 5 is coupled to one input of a differential driver 6. The other input of differential driver 6 is coupled to a driver control signal output 2a of the controller 2.

The differential driver 6 is coupled to supply the RF signal to an antenna circuit 7. In this example, the antenna circuit 7 is a tuned circuit comprising respective capacitors 8 and 9 in series with an antenna coil 10 and further capacitors 11 and 12 each coupled between a respective one of the capacitors 8 and 9 and ground (earth). The presence of all four capacitors serves to reduce unwanted carrier harmonics but it may be possible to omit some of the capacitors, for example capacitors 11 and 12, where the signal generated by the differential driver 6 does not exceed electromagnetic energy emissions regulations.

One end of the antenna coil 10 is coupled to ground via a filter arrangement comprising a series connection of capacitors 13 and 14 for filtering out extraneous signals. The junction between the capacitors 13 and 14 is coupled to a demodulator 15 (which may be, for example, a simple diode demodulator or synchronous demodulator). The output of the demodulator 15 is coupled to a data input 16 of the controller 2.

The RFID reader 1 also has a control circuit 17 for controlling operation of the RFID reader 1 in accordance with the strength of the magnetic field generated by the antenna circuit coil 10 so as to control and stabilise the magnetic field transmitted by the antenna circuit.

The control circuit 17 comprises a sense coil 18 positioned so as to be able to sense or detect at least part of the magnetic field (H field) produced by the antenna circuit coil 10, that is the sense coil lies (either completely or partially) within the H field of the antenna circuit coil 10.

As shown in FIG. 1, the sense coil does not form part of a resonant circuit. The sense coil 18 may however form part of a resonant sense coil circuit similar to the antenna circuit 7. FIG. 1 shows the sense coil 18 as being adjacent to the main antenna coil 7. The sense coil needs to be placed partially or completely within the H field generated by the antenna circuit 7 and, in order to sense the magnetic field generated by the antenna circuit, at least part of the sense coil should be parallel to that magnetic field or to a component of that magnetic field. The sense coil should ideally be placed co-axially with the antenna coil, for example it may be formed inside the antenna circuit 7 or above or below the antenna circuit 7. Although FIG. 1 shows a single sense coil, multiple sense coils may be placed in series around the antenna coil 10, above or below the antenna coil 10 or within the antenna circuit 7. The maximum distance between the two coils will be determined by the properties of the antenna circuit 7 and extent of the H-field which is generated by such an antenna circuit. The positioning of the sense coil 18 may, however, vary from reader to reader and will, for example, depend on both the lay-out of the RFID reader (whether an integrated circuit or a discrete device type reader) and the environment within which the RFID reader is intended to operate.

The sense coil 18 is coupled to a sense amplifier 19 for amplifying and filtering the signal supplied by the sense coil 18. The sense amplifier 19 has an output 20 coupled to one input (as shown the negative input) of a differential or error amplifier 21. The other input of the error amplifier 21 is coupled to a required magnetic field strength output 222 of the controller 2 which provides a reference signal indicating the magnetic field strength required to be produced by the antenna circuit 7. The type of reference signal provided by the controller 2 on the required magnetic field strength output 222 will depend upon the nature of the error amplifier. Thus, for example, the reference signal may be a comparison or threshold voltage, or a comparison or threshold current. In each case, the error amplifier 21 is operable to produce a signal dependent on its evaluation of the difference between the signal received by the sense coil 18 and the reference signal on the required magnetic field strength output 222 from the controller 2.

The operation of the sense amplifier 19 will depend upon the operation of the control circuit 17 and the RFID reader. For example, where the signal received by the sense coil 18 is modulated, then the sense amplifier 19 may filter out that modulation. As another possibility, the control circuit 17 may track any modulation and the processing techniques may be adjusted to ensure that any such modulation does not affect the control signals provided by the control circuit 17. As another possibility, the RFID reader 1 may be designed such that the control circuit 17 is only operable at certain times or for certain periods, for example when an un-modulated magnetic field is generated at antenna circuit coil 10. Thus, for example, the controller 2 may only activate the control circuit 17 when the magnetic field is un-modulated.

The output of the error amplifier 21 is supplied to a control loop stabiliser 22 (identified as PID in FIG. 1) to produce a signal which can be used by the controller 2 to control the magnetic field strength at the antenna 10. The processing technique used by the control loop stabiliser 22 will depend on the complexity required and processing power available. The control loop stabiliser 22 may be implemented entirely in software or using analogue circuitry or a combination of both. FIG. 1 shows the control loop stabiliser 22 as a functional block separate from the controller 2. In such a case, the control loop stabiliser 22 functionality may be provided by, for example, a processor or an operational amplifier. As another possibility, the signal processing functionality may be provided by the controller 2.

In the example illustrated by FIG. 1, the control loop stabiliser 22 (or the signal processing functionality provided by the controller 2) is configured to implement PID (proportional, integral, derivative) techniques. The output from the error amplifier 21 is thus processed by the control loop stabiliser 22 to produce three signals: a proportional (that is unprocessed) signal, an integrated signal (that is the integral signal) and a differentiated signal (that is the derivative signal). These three signals are combined to produce an output control signal representing any adjustment required. A constant may also be applied to each of the P, I and D signals providing variable effect on the end combined signal.

As described above, a single error amplifier 21 is provided. As another possibility, the error amplifier 21 may be replaced by multiple operational amplifiers each coupled to receive the output 20 from the sense amplifier 19. In this example, each of the operational amplifiers will be configured to generate a respective one of the proportional signal, the integral signal and the derivative signal and the control loop stabiliser 22 will be configured to combine the outputs of these operational amplifiers, after multiplication by appropriate constants.

Any appropriate algorithm may be used to implement the PID processing. An example algorithm can be represented as follows:

Output(t)=PE(t)+1/I∫E(t)dt+Dd/dt E(t)

Where t=time, E is the received RF signal strength or output from the sense amplifier, P is the proportional error, I is the integral of the error and D is the derivative of the error. Constants may be used to determine the effect that each of the three inputs (P, D and I) has on the combined comparison and therefore effect on the control of the RF signal being generated.

The proportional error P is used for basic control loop speed and stability. The integral I of the error is usually used to represent the sum of previous errors within a given timescale and therefore has an averaging effect. The derivative D of the error is used to speed up control loop stabilisation, and can be used to identify where there are large or rapid changes in the RF signal strength being generated.

The control loop stabiliser 22 need not necessarily use PID techniques. Other possibilities include the use of preset software algorithms or fuzzy logic. Cascades of PID techniques can also be used.

The output of the control loop stabiliser 22 is coupled to a correction signal input 24 of the controller 2 to enable the controller 2 to control the output of the differential driver 6 by controlling the signal supplied to at least one of the signal generator 5 and the differential driver 6 in accordance with the output of the control loop stabiliser 22. Alternatively, the control loop stabiliser 22 may be directly connected to at least one of the signal generator 5 and the differential driver 6 to control the output of the differential driver 6 directly.

The RFID reader 1 will of course have or be associated with a power provider 25 for providing a power supply for the various components of the RFID reader 1. In the interests of simplicity, the couplings of most of the various components of the RFID reader 1 to the power provider 25 are omitted in FIG. 1. The power provider 25 may be, for example, an internal battery or may be a coupling to a power supply provided by any host apparatus, system or device of the RFID reader 1.

The components of the RFID reader 1 apart from the power provider 25, and the antenna coil 10 and sense coil 18 may be provided by a single semiconductor integrated circuit chip or by several separate chips or discrete devices mounted on a printed circuit board. Whether particular functions are implemented by analogue or digital circuitry will depend on the design route chosen. For example, the error detection and feedback circuitry may be implemented in either the analogue or digital domain.

To assist the explanation of the operation of the RFID reader 1, FIG. 2 shows a functional block diagram of an RFID data storage tag 30 that may be read by the reader 1 when the tag 30 is in the read range (H field) of the reader 1. In this example, the RFID tag or transponder is a passive device, where “passive” in this context means that the RFID tag derives power from the RF signal supplied by the reader (it is not self-powered). As another possibility, the RFID tag may be an active device having a power provider (similar to that shown for an RFID reader in FIG. 1 as 25) for example at least one of a battery or a coupling to a power source of host device, system or apparatus containing or associated with the RFID tag.

The tag 30 has a data store 31 containing data that may be read by the reader 1 shown in FIG. 1. In this example, the data store 31 is a serial read-only memory (ROM). It may, however, be any form of non-volatile memory that does not require battery backup such as a ROM, an EE-PROM (electrically erasable programmable ROM), a flash memory, F-RAM and so on.

The tag 30 has an antenna circuit 32 comprising, in this example, an antenna coil 33 in parallel with a capacitor 34. The tag 30 also has a power deriver 35 for deriving a power supply for the tag 30 from an RF signal coupled to the antenna circuit 32. As shown in FIG. 2, the power deriver 35 comprises series-connected diodes 36 and 37 and a capacitor 38 coupled between the antenna circuit 32 and a junction 39 between the anode of the diode 36 and the cathode of the diode 37. The cathode of the first diode 36 is connected to a first power supply rail P1 (Vdd) while the anode of the second diode 37 is connected to a second power supply rail P2 (Vss). The capacitor 38 and the diodes 36 and 37 act effectively as a voltage doubler enabling the peak to peak voltage of a received RF signal inductively coupled to the tag 30 to be used to derive a power supply for the tag 30. It will, of course, be appreciated that, in the interests of simplicity, the power supply connections to the remaining components of the tag are not shown.

The tag 30 also has a controller 40 for controlling (via control line 41) reading of data from the data store 31 and supply of that data to a modulator 42 coupled to the antenna circuit 32. In the example shown, the modulator 42 comprises a series-connection of a capacitor 43 and an FET 44 coupled across the capacitor 34 of the antenna circuit 32 with the gate electrode of the FET 44 coupled to an output 45 of the data store 31 so that output of data from the data store 31 modulates the load on the antenna circuit 32 and thus on any antenna circuit 7 (FIG. 1) inductively coupled to the antenna circuit 32.

The tag 30 may be a synchronous tag in which case the tag controller 40 will have a clock deriver input 46 coupled to receive an RF signal coupled to the antenna circuit 32 so that the tag controller 40 can derive a clock signal directly from the received RF signal or from periodic interruption by the reader controller 2 (FIG. 1) of the RF signal. Alternatively, the tag 30 may be an asynchronous tag in which the tag controller 40 will have its own clock.

The tag controller 40 may simply control reading of data from the data store 31 when the tag is powered or may be more sophisticated and may allow data and/or control instructions to be retrieved from a modulated RF signal supplied by a reader 1. An example of the former simple type of tag is shown in FIG. 6 of WO02/093881 while an example of a tag that can receive and store data and/or instructions is shown in FIG. 7 of WO02/093881, the whole contents of which are hereby incorporated by reference. The tag controller 40 may be, for example, a microprocessor, a microcontroller, a controller (for example a reduced instruction set computer) or state machine. The choice will depend on the design of tag used and operational requirements.

As will be appreciated from the above, the controller 2 of the reader 1 shown in FIG. 1 is configured to control communication with a tag. The actual nature of this control will depend upon the reader and tag configuration or type. Thus, the reader control 2 will control the generation of an RF signal by the signal generator 5, the interruption, where required, of that signal to enable a tag to generate a clock signal, the protocols under which the RFID communicator 1 operates, any modulation of the RF signal and any response to any received modulation of the generated RF signal. As will be appreciated, the pattern of any modulation will represent a series of digital ones and zeros determined by the binary data being transmitted.

In operation of the RFID reader 1 shown in FIG. 1, the controller 2 controls at least one of the signal generator 5 and differential driver 6 to affect both generation of the RF signal as required and modulation of that RF signal.

In the case of a simple tag, the tag controller 40 may cause data to be read from the tag data store 31 upon powering up of the tag, that is once the power deriver 35 of the tag 30 derives a power supply for the tag 30 from the inductively coupled RF signal. Where the tag 30 is more sophisticated, then the communications protocol under which the tag and the reader operate may require some form of communication or handshaking to occur before the tag controller 40 causes data to be read from the tag data store. The reading of data from the data store 31 causes the modulator 42 to modulate the load on the antenna circuit 32 (and thus on the antenna circuit 7 inductively coupled thereto) in accordance with the data read from the data store 31. The modulation by the tag 30 of the RF signal is extracted by the reader demodulator 15 and supplied to the controller 2. The capacitors 13 and 14 limit the amplitude of the signal input to the demodulator 15 and so avoid over-voltage damage to the demodulator 15.

The response of the reader controller 2 to the data extracted by the demodulator 10 will of course depend upon the nature of the data and the protocols under which the reader and tag are operating. For example, where the tag 30 is capable of receiving data and/or control signals, then the reader controller 2 may cause the RF signal generated by the signal generator 5 to be modulated with response data and/or control signals. Thus, data received or transmitted by the reader 1 may be in the form of control instructions and/or other data. The tag data may, for example, provide at least one of: identification of the tag or a host device, system or apparatus containing or associated with the tag, instructions to write certain data to the reader data store 4; instructions to supply certain data to a host device, system or apparatus containing or associated with the reader 1.

When the controller 2 causes the signal generator 5 to generate an RF signal, the digital signal generated by the signal generator 5 is fed into the differential driver 6 which outputs complementary pulses to the antenna circuit 7. The resulting oscillating magnetic H field produced by the antenna circuit 7 is inductively coupled to the antenna circuit of any tag 30 (FIG. 2) within the H field, that is within the read range of the reader 1. The designed read range (that is the distance over which the tag antenna coil 33 is intended to be able to couple inductively to the magnetic field (H field) of the reader 1 antenna coil 10) will depend upon the actual reader and tag antenna circuit design and constraints, in particular upon the size and configuration of the antenna coils and the strength of the RF signal supplied by the reader 1. For example, the H field or read range may be designed to lie in a range up to 1 metre.

When the controller 2 causes the signal generator 5 to generate an RF signal, the resulting magnetic field (H field) will be sensed by the sense antenna coil 18.

The magnetic field sensed by the sense antenna coil 18 will be the magnetic field resulting from the actual RF signal supplied to the antenna circuit 7 and the antenna circuit configuration as modified by the effect of metallic and/or magnetic material and conductive loops in proximity to the antenna circuit, that is as modified by the effect of the “electromagnetic environment” of the reader 1. This electromagnetic environment may include contributions from the reader or tag housing or casing, from a host device or apparatus incorporating the reader or tag, from a user of the reader or tag, from other devices, apparatus or objects in the vicinity of the reader or from any combination of the foregoing.

The RF signal received by the sense coil 18 is fed to the sense amplifier 19 which amplifies and filters the received RF signal (or magnetic field) to produce at output 20 a sense signal which is proportional to the voltage or current of the received RF signal. The output 20 of the sense amplifier 19 is coupled to, in this example, the negative input of the differential or error amplifier 21 which compares the sense signal 20 with a reference signal output by the controller 2 on the required magnetic field strength output 222. This reference signal represents the ideal signal strength/incident magnetic field strength required from the antenna circuit 7 and is pre-set and stored by the controller 2.

The error amplifier 21 generates a difference voltage or current or other difference signal. The difference signal is then processed by the control loop stabiliser 22 (or the controller 2 where the functionality of the control loop stabiliser is provided by the controller 2) in the manner described above to produce a RF signal control signal which is supplied to the correction signal input 24 of the controller 2.

The RF signal control signal indicates to the controller 2 whether the sensed magnetic field is higher or lower than the required magnetic field. The controller 2 controls at least one of the signal generator 5 and differential driver 6 in accordance with the magnetic field strength control signal to affect the gain of the differential driver 6 thereby changing the level of the RF signal supplied to the antenna circuit 7. As other possibilities, the drive level may be affected by the controller 2 or the PID techniques may be selected so as only to produce an RF signal control signal 24 when the received signal strength at sense coil 18 is lower than a desired field strength or threshold voltage.

In the event the RF signal control signal indicates that the sensed magnetic field is lower than the required magnetic field, the controller 2 controls at least one of the signal generator 5 and differential driver 6 to increase the level of the RF signal supplied to the antenna circuit 7. Likewise where the magnetic field strength being transmitted is higher than required, the controller 2 may, but need not necessarily, control at least one of the signal generator 5 and differential driver 6 to decrease the level of the RF signal supplied to the antenna circuit 7. Decreasing the level of the RF signal where the magnetic field strength being transmitted is higher than required may have an additional advantage of saving power.

FIG. 3 shows a functional block diagram of another embodiment of an RFID reader 1′ in accordance with the invention. As can be seen by comparing FIGS. 1 and 3, the RFID reader 1′ shown in FIG. 3 differs from that described above in the way in which the RF signal is controlled in accordance with the sensed magnetic field. In this embodiment, the operation of the differential driver 6′ is not controlled in accordance with the sensed magnetic field. Rather, the output of the control loop stabiliser 22 provides a control signal for an antenna tuning control circuit 50. The antenna tuning control circuit 50 directly controls or affects the capacitance of at least of the capacitors 8′, 9′, 11′ and 12′ of the antenna circuit 7′ so as to alter the resonant frequency of the antenna circuit 7′. For example, one or more of these capacitors may comprise a switched capacitor network controllable by the antenna tuning control circuit 50 or the antenna tuning circuit may comprise additional capacitor elements and may couple or decouple these into the antenna circuit 7′, depending upon the control signal provided by the control loop stabiliser 22.

Any of the modifications described above with reference to FIG. 1 may be applied to the RFID reader shown in FIG. 3. Thus, for example, as with the RFID reader 1, the error amplifier 21 may comprise a series of operational amplifiers each performing part of the PID process. Also, the control loop stabiliser 22 may be comprised within the controller 2, in which case it will be the controller 2 which provides the control signal to the antenna tuning control 50.

FIG. 3 may also be implemented as an active RFID tag rather than an RFID reader if the controller 2 is configured not to initiate but to respond, that is if the controller 2 is configured to allow RF signal generation and any modulation only in response to an RF signal (H field) from an RFID reader or an NFC communicator in initiator mode.

FIG. 4 shows a functional block diagram of another embodiment of an RFID reader 1″ in accordance with the invention. In this embodiment the control loop stabiliser 22 (referenced “PID” in the Figure) is used both to control the magnetic field strength generated by the RFID reader 1″ and additionally to detect modulation of that magnetic field strength by an external near field communicator.

The controller 2, signal generator 5, differential driver 6 and main antenna circuit 7 (comprising the main antenna coil 10 and associated capacitors 8, 9 11 and 12), and data store 4 correspond to the same components described above with reference to FIG. 1 and operate in the same way as described for the equivalent components in FIG. 1 Likewise the control loop stabiliser 220 operates in the same way as the control loop stabiliser 22 in FIG. 1 as regards the strength of the magnetic field generated by the RFID reader 1″. In this embodiment, however, the control loop stabiliser 220 is also used by the RFID reader 1″ to detect modulation of the magnetic field by an external near field communicator.

As shown in FIG. 4, the sense coil 18 forms a sense coil resonant circuit 51 with capacitors 52, 53, 54 and 55. The use of a resonant circuit is however not necessary and the capacitors may be omitted.

As in the earlier embodiments, the sense coil circuit 51 is coupled to a sense amplifier 19 having its output 20 coupled to one input (as shown the negative input) of a differential or error amplifier 21. Again as in the earlier embodiments, the other input of the error amplifier 21 is coupled to a required magnetic field strength output 222 of the controller 2 which provides a signal indicating the magnetic field strength required to be produced by the antenna circuit 7.

The output of the error amplifier 21 is again coupled to the input of a control loop stabiliser 220 which is again configured to carry out known control loop stabilising techniques, for example “PID” (proportional, integral, derivatives) techniques as discussed above. As discussed above such control loop stabilising techniques may be carried out within a PID processor or controller or within the controller 2 or by a series of operational amplifiers able to perform the necessary processing.

Because in this embodiment the control loop stabiliser 220 is configured also to detect modulation of the magnetic field by an external near field communicator, the controller 2 has an additional control output 223 coupled to control the sense amplifier 19 and there is an additional output 224 from the control loop stabiliser 220 to the demodulator 15.

During operation of the RFID reader 1″ shown in FIG. 4, when the controller 2 causes the signal generator 5 to generate an RF signal, the digital signal generated by the signal generator 5 is fed into the differential driver 6 which outputs complementary pulses to the antenna circuit 7. The resulting oscillating magnetic H field produced by the antenna circuit 7 is inductively coupled to the antenna circuit of any tag (for example the tag 30 shown in FIG. 2) within the H field, that is within the read range of the reader 1″.

Whenever the controller 2 causes the signal generator 5 to generate an RF signal, the resulting magnetic field (H field) will be sensed by the sense antenna coil circuit 51.

The magnetic field sensed by the sense coil circuit 51 will again be the magnetic field resulting from the actual RF signal supplied to the antenna circuit 7 and the antenna circuit configuration as modified by the effect of the “electromagnetic environment” of the reader. The magnetic field sensed by the sense antenna coil circuit 51 will also include the effect of any modulation of the RF signal by the reader 1″ or by a tag with which the reader is communicating.

The RF signal sensed by the sense coil circuit 51 is fed to the sense amplifier 19. The controller 2 controls the extent of filtering carried out by the sense amplifier 19. Thus, when the RFID reader 1″ is transmitting a modulated magnetic field at antenna circuit 7, the controller 2 causes the sense amplifier 19 to filter out any modulation. In contrast, when the RFID reader 1″ is not supplying a modulated magnetic field (for example, when it is waiting for a response from a near field communicator within range), the controller 2 instructs the sense amplifier 19 not to filter out modulation. Thus only incoming modulation is passed by the sense amplifier 21.

The output 20 of the sense amplifier 19 is again coupled to the negative input of a differential or error amplifier 21 which compares the sense signal with the reference signal output by the controller 2 on a required magnetic field strength output 222.

The error amplifier 21 generates a difference voltage or current or other difference signal. The difference signal is then processed by the control loop stabiliser 220 in the manner described above to produce a control signal which is supplied to a correction signal input 60 of the controller 2 in the same way as described for FIG. 1 above. The controller controls at least one of the signal generator 5 and differential driver 6 in accordance with the control signal to control the level of the RF signal supplied to the antenna circuit 7 in the manner described above with reference to FIG. 1.

When the RFID reader 1″ is waiting for incoming signal modulation, for example once the RFID reader 1″ has finished transmitting its desired modulation magnetic field (for example a wake-up request to any RFID tags within range), the controller 2 supplies a control signal 223 to the sense amplifier 19 to cause the sense amplifier 19 to stop filtering out any modulation. In these circumstances, where the magnetic field sensed by the sense coil circuit 51 is modulated, the modulation will produce its own error reading distinct from an error generated merely as a result of, for example, low signal strength. The control loop stabiliser 220 can detect the error resulting from such modulation in a number of ways, for example the control loop stabiliser 220 may look for an error within a particular band of the received modulated magnetic field, or for the rate of change that is. frequency of effects on the magnetic field. To do this the relationship between the proportional, integral and derivative values may be altered, for example integral errors may assume a higher importance and the constants applied to such errors may therefore be varied.

As described above the sense amplifier 19 filters out modulation in accordance with instructions from the controller 2. The modulation filtering may be carried out anywhere in the control circuit 170 before the control loop stabiliser. For example a separate filter may be provided or the error amplifier 21 may incorporate an initial filtering stage. As another possibility, there may be no filtering out of the modulation. In this latter case, the control loop stabiliser 220 (or controller 2 where the signal processing functionality is provided by the controller) will be configured to track any modulation, and to ignore any modulation where the controller 2 indicates that the modulation was effected by the RFID reader 1″ but to detect and process any modulation where the controller 2 indicates that the RFID reader 1″ is waiting for a response.

When the control loop stabiliser 220 produces an error signal consistent with modulation of the magnetic field, the control loop stabiliser 220 supplies the modulated RF signal to the demodulator 15 for demodulation and data retrieval. Additional amplifiers may be provided between the PID 22 and demodulator 15 to amplify any received modulation to assist demodulation. The extent of any such amplification will be controlled by the control loop stabiliser 220.

FIG. 5 shows a functional block diagram of an embodiment of an NFC communicator 60 in accordance with the invention. Unlike the RFID readers described with reference to FIGS. 1, 3 and 4, an NFC communicator is capable of communicating with transponders or tags, RFID transceivers or readers and other NFC communicators. Examples of such NFC communicators are described in ISO/IEC 18092 and ISO/IEC 21481. Thus, an NFC communicator can operate: 1) in an initiator mode in which the NFC communicator functions in a similar fashion to an RFID reader and will transmit an RF signal; and 2) in a target mode in which the NFC communicator waits for receipt of an RF signal from another NFC communicator operating in initiator mode or an RFID reader, that is it functions like a tag or transponder. NFC communicators may communicate with each other using an active or passive protocol. When using the active protocol, an initiator mode NFC communicator transmits an RF signal and then ceases RF signal transmission and a target mode NFC communicator responds by transmitting its own RF signal and then ceasing RF signal transmission. When using the passive protocol, an initiator mode NFC communicator transmits its RF signal and maintains that RF signal throughout the duration of the communication cycle and a target mode NFC communicator responds by causing modulation of the transmitted RF signal.

As shown in FIG. 5, the NFC communicator 60 includes a controller 61 for controlling overall operation of the NFC communicator in accordance with control data and/or instructions and other data stored by an internal memory of the controller 61 and/or a data store 62 coupled to the controller. The controller 61 may comprise a microcontroller, RISC computer or state machine, for example.

The controller 61 is coupled to a signal modulator 63 for modulating an RF signal in accordance with data provided by the controller 61, to a modulation controller 64 and to a differential driver 65 which is also coupled to the outputs of the signal modulator 63 and the modulation controller 64. The modulation controller 64 may control the amplitude of the signal supplied by the modulator 63. As shown, the modulation controller 64 is separate from the controller 61. The functionality of the modulation controller may however be provided by the controller 61.

The differential driver 65 is coupled to supply an RF signal modulated under the control of the controller 61 to an antenna circuit 66 comprising an antenna coil 67. In this example the RF signal fed to the antenna circuit 66 is of a digital square-wave form and so filtering components (as shown inductors 68 and 69 and capacitors 70 to 75) may be required to reduce harmonics of the carrier so that electromagnetic energy emissions regulations are met. A clamp 76 is provided across the antenna circuit 66 to divert current in the event of a high voltage occurring to reduce the risk of high voltages destroying chip functionality.

The NFC communicator 60 also has a demodulator 80 coupled (as shown via capacitor 81 which is itself coupled to ground or earth via another capacitor 82) to the antenna circuit 66 for extracting the modulation from a received modulated RF signal.

The NFC communicator 60 shown in FIG. 5 has two mechanisms for enabling communication of data when the NFC communicator is in the target mode. One mechanism is a load modulation mechanism as described above with reference to FIG. 2 and the other is an interference mechanism which simulates load modulation.

The load modulation mechanism is provided by a transistor 83 (as shown a FET) coupled across the antenna coil 67. The controller 61 has a data output 84 coupled to the gate or control electrode of the transistor 83 and, when this mechanism is operational, the transistor 83 is switched on and off in accordance with the data supplied by the controller 61, thereby modulating the load on the antenna circuit 66 and thus an RF signal supplied by the initiator NFC communicator or RFID reader.

The interference or simulated load modulation mechanism is provided by a phase-locked loop 90 comprising, in this example, a voltage controlled oscillator (VCO), a phase detector, a loop filter and preferably a sample and hold circuit). The phase-locked loop 90 is coupled, as shown via capacitor 81, to the antenna circuit 66. The phase-locked loop 90 generates an internal RF signal which is supplied to the modulator 63 when the NFC communicator 60 is in initiator mode. When, however, the NFC communicator 60 is in target mode, the phase-locked loop 90 is controlled by an enable signal output 92 of the controller 61 to bring the internally generated RF signal into phase (“lock”) with an external RF signal coupled to the antenna circuit 66 (that is an RF signal from an initiator mode NFC communicator or RFID reader) so that the internally generated RF signal has a fixed phase relationship to the external RF signal. The phase-locked loop 90 provides a signal to an input 93 of the controller 61 when phase lock has been achieved. This ensures that the target mode NFC communicator can communicate with the initiator mode NFC communicator or RFID reader by modulating its internally generated RF signal.

The NFC communicator 60 of course also has a power provider 91. For convenience the connections of the power provider to the remainder of the NFC communicator 91 are not shown. The power provider 91 may comprise at least one of a power supply such as a battery provided within the NFC communicator 60 and or a connection to a power supply of a host device, apparatus or system. The power provider could also comprise a power deriver for deriving a power supply from an RF signal inductively coupled to the antenna circuit 66 when the NFC communicator is in target mode.

The controller 61 controls RF signal generation, modulation characteristics of any transmitted RF signal, response to any received RF signal, interpretation of any received demodulated signal, mode of operation (for example initiator or target or active or passive mode) and the communication protocol under which the NFC communicator 60 operates. In responding to a received signal when in target mode, the NFC communicator will respond in a manner dependent upon whether the NFC communicator 60 is operating under the active or passive protocol. Where the NFC communicator is operating under the active protocol, the controller 61 will cause the NFC communicator to respond by generation of a phase-locked modulated signal using the phase-locked loop mechanism whereas in the event the NFC communicator is operating under the passive protocol, the controller 61 may cause the received RF signal to be directly modulated by switching the transistor 83 in accordance with the data to be communicated or may use the phase-locked loop 90 mechanism to effect modulation by interference with the received RF signal (simulated load modulation).

The NFC communicator 60 may use a combination of load modulation or carrier interference or may alternatively use only one or the other form of communication. As another possibility, the NFC communicator 60 may comprise multiple antennas, one being used for response to a received RF signal and the other being used for transmission of an RF signal with the antennas being switched on according to need, under the control of the controller of the NFC communicator. Thus, where the NFC communicator is acting in initiator mode, the antenna selected for transmission of an RF signal will be used while where the NFC communicator is, for example, acting as a passive target (i.e. similar to an RFID transponder) the controller 61 will switch the antennas, thereby utilising an antenna more suited to load modulation of an incoming RF signal.

Further details of how the NFC communicator may be configured to function in both tag emulation (target) and reader emulation (initiator) mode can be found in WO2005/045744, the whole contents of which are hereby incorporated by reference.

As with the RFID reader 1 shown in FIG. 1, the NFC communicator 60 has a control circuit 100 for controlling operation of the NFC communicator 60 in accordance with the strength of the magnetic field generated by the antenna circuit coil 66. As shown in FIG. 5, the control circuit 100 comprises a sense coil 101 positioned so as to be able to sense or detect at least part of the magnetic field (H field) produced by the antenna circuit coil 67, that is so that the sense coil 101 lies within the H field of the antenna circuit coil 67. The sense coil 101 is coupled to a sense amplifier 102 having its output coupled to one input (as shown the negative input) of a differential or error amplifier 103. The other input of the error amplifier 103 is coupled to a required magnetic field strength output 104 of the controller 61 which provides a signal indicating the magnetic field strength required to be produced by the antenna circuit 66.

The output of the error amplifier 103 is coupled to the input of a control loop stabiliser 105 which is configured to carry out known control loop stabilising techniques, for example “PID” (proportional, integral, derivatives) techniques. The control loop stabilising techniques may alternatively be carried out within the controller 61 (or where the NFC device 60 is part of a larger device within the host processor of the larger device).

The output of the control loop stabiliser 105 is coupled to a correction signal input 106 of the controller 61 to enable the controller to adjust the signal supplied to at least one of the modulation controller 64 and differential driver 65 in accordance with the output of the control loop stabiliser 105.

In operation of the NFC communicator shown in FIG. 5, the sense coil 101 detects the magnetic field at the antenna circuit coil 67. The detected signal is amplified and filtered by the sense amplifier 102 and fed to the error amplifier 103 which compares the received signal against a pre-set desired signal level or threshold level output 104 representing the required magnetic field strength provided by the controller 61 and produces an error or difference signal. This error or difference signal is processed by the control loop stabiliser 105 using PID techniques to provide instruction data utilisable by the controller 61 to control the modulation controller 64 and differential driver 65 to adjust or modify the RF signal fed to the antenna circuit 66 by the driver 65 to compensate for the difference between the sensed magnetic field strength and the required magnetic field strength.

In this embodiment, the control circuit may filter out any modulation or the controller may control the control circuit so that it operates only when there is no modulation.

It will be appreciated that the control circuit 100 shown in FIG. 5 functions in a similar manner to the control circuit 17 shown in FIG. 1. It will also be appreciated that the control circuit 100 shown in FIG. 5 may be replaced by the control circuit shown in FIGS. 3 or 4 or by any of the variations described above for such control circuits.

The near field communicator may be a stand-alone device or may be comprised within a host device, apparatus or system such as a consumer product, for example a mobile telephone, personal digital assistant, digital camera, or a laptop, notebook, or other computer. Also near field communicators in accordance with the invention may be used in other electrical or electronic products, for example consumer products such as domestic appliance or personal care products, and other electrical or electronic devices, apparatus or systems. Other areas of application are ticketing systems, for example in tickets (for example parking tickets, bus tickets, train tickets or entrance permits or tickets) or in ticket checking systems, toys, games, posters, packaging, advertising material, product inventory checking systems and so on.

Where comprised within a host device, apparatus or system, the functionality or at least some of the functionality of the near field communicator may be provided by the host device, apparatus or system and an interface provided between the host system controller and the other components of the near field communicator. FIG. 6 shows a functional block diagram of a host device, apparatus or system 200 comprising a near field communicator 201 in which the near field communicator controller 202 is coupled via an interface 203 to a host controller 204 which controls operations of the host device, apparatus or system which may be, for example, a mobile telephone. As shown, the near field communicator 201 has the functional elements discussed above discretely located within the host device, apparatus or system, namely antenna circuitry 205 having an antenna coil 206, control circuitry 207 for controlling operation of the near field communicator in accordance with the magnetic field strength sensed by a sense coil 208, signal providing circuitry 209 for providing the RF signal modulated in accordance with control data and/or other data from the near field communicator controller 202, a demodulator 210 for extracting modulation from an RF signal coupled to the near field communicator 201, and a data store 211. The functionality of the near field communicator 201 may, however, be dispersed throughout the host device, apparatus or system 200. In addition the data storage or at least part of the data storage may be provided by the host device, apparatus or system and at least some instructions, control data and/or other data may be provided by the host device, apparatus or system or input by a user via a user interface 212 of the host device, apparatus or system which may comprise a display 213 and a keyboard 214, for example.

FIG. 7 shows a simplified view of a mobile telephone 250 forming such a host device with the main body 300 of the mobile telephone 250 shown separated from its fascia 301 to show that, as one possibility, the main and sense antennas or coils 206 and 208 of the near field communicator may be located opposite one another within each part of the mobile phone so that their coil axes are coincident.

Reference numeral 251 represents the aerial of the mobile telephone.

As described above, the control loop stabilising functionality enables compensation for the “electromagnetic environment”. It also compensates for any impedance effects resulting from power source, for example battery, voltage variation.

The control loop stabilising functionality described above may be operable whenever a magnetic field is being generated by a near field communicator. Alternatively the control loop stabilising functionality may be activated by the near field communication controller. For example where an end user of the near field communicator only wants to use the control loop stabilising function to auto-tune near field communicators for application within different devices, the control stabilising functionality may be turned on, as part of the testing and programming process and then disabled thereafter. Alternatively the control loop stabilising functionality may only be turned on where a non-modulated RF signal is transmitted by a near field communicator. The operation of the near field communicator may be adjusted to provide for a preliminary transmission of an un-modulated field to enable the control loop to adjust operation prior to any modulation being carried out.

It should be appreciated that FIGS. 1 to 7 are functional block diagrams and should not be taken to imply that the functional elements shown in those Figures are necessarily physically separate components. Similarly the fact that a single functional block is shown should not be taken to imply that function is necessarily carried out by a single component. Rather, the functions represented by the functional blocks shown in FIGS. 1 to 7 may be implemented in any appropriate manner using any appropriate combination of hardware (with analogue and/or digital circuitry as appropriate), software and firmware. For example, as described in the above embodiments, the control loop stabiliser is separate from the controller. The control loop stabilising functionality may, however, be provided by the controller, in which case the error amplifier will feed directly to the controller. Similarly, the functionality of the error amplifier and control circuit may both be provided by the controller 2.

The reference signal representing the required magnetic field strength is described above as being provided by the controller. As another possibility, the reference signal may be stored within the error amplifier.

1. A near field communicator comprising: a driver operable to supply a drive signal to drive an antenna to generate a magnetic field; a magnetic field sensor located so as to be within a magnetic field generated by the antenna to sense a magnetic field characteristic; and a controller operable to provide a control signal to compensate for any difference between the magnetic field characteristic sensed by the magnetic field sensor and a predetermined parameter.

2. A near field communicator according to claim 1, wherein the characteristic comprises magnetic field strength and the predetermined parameter comprises a parameter representative of a desired magnetic field strength.

3. A near field communicator according to claim 1, wherein the controller comprises a comparator operable to compare a signal representative of the magnetic field characteristic and a signal representative of the predetermined parameter to provide an error signal and a control signal provider operable to provide the control signal to control the operation of the driver in accordance with the error signal.

4. A near field communicator according to claim 1, further comprising a comparator operable to compare a signal representative of the magnetic field characteristic and a signal representative of the predetermined parameter to provide an error signal, wherein the controller is operable to provide the control signal to control the operation of the driver in accordance with the error signal.

5. A near field communicator according to claim 3, wherein the comparator comprises at least one operational amplifier.

6. A near field communicator according to claim 1, wherein the controller is operable to use a signal representative of the magnetic field characteristic and a signal representative of the predetermined parameter to provide proportional, integral and differential signals and to provide the control signal on the basis of the proportional, integral and differential signals.

7. A near field communicator according to claim 1, wherein the controller is operable to provide the control signal using at least one of PID, cascaded PID processes, pre-set software algorithms or fuzzy logic.

8. A near field communicator according to claim 1, wherein the driver is operable to supply an oscillating, for example RF, drive signal to drive the antenna.

9. A near field communicator according to claim 1, wherein the controller is operable to provide as the control signal a signal to control the operation of the driver.

10. A near field communicator according to claim 9, wherein the controller is operable to provide as the control signal a signal to control the level of the drive signal.

11. A near field communicator according to claim 1, wherein the controller is operable to provide as the control signal a signal to control an antenna tuner operable to tune the antenna.

12. A near field communicator according to claim 1, wherein the magnetic field sensor comprises at least one sensor coil.

13. A near field communicator according to claim 1, comprising a receiver operable receive a modulated magnetic field and a demodulator operable to extract modulation from the detected magnetic field.

14. A near field communicator according to claim 13, wherein the receiver comprises the antenna.

15. A near field communicator according to claim 13, wherein the receiver comprises the magnetic field sensor and the controller is operable to detect incoming modulation and to supply the modulated signal to the demodulator.

16. A near field communicator according to claim 13, further comprising a filter operable to filter out modulation from a signal representing the sensed characteristic.

17. A near field communicator according to claim 1, further comprising a modulator operable to modulate the magnetic field generated by the antenna.

18. A near field communicator according to claim 17, wherein the modulator is operable to modulate the magnetic field generated by the antenna in accordance with data to be communicated to another near field communicator.

19. A near field communicator according to claim 1, wherein the controller is operable to increase the level of the drive signal in the event that the sensed magnetic field characteristic is less than the predetermined parameter.

20. A near field communicator according to claim 1, wherein the controller is operable to decrease the level of the drive signal in the event that the sensed magnetic field characteristic is greater than the predetermined parameter.

21. A near field communicator according to claim 1, comprising an RFID tag, an RFID reader or an NFC communicator.

22. A device, system or apparatus having the functionality provided by a near field communicator in accordance with claim 1.
